(19) United States
(12) Patent Application Publication
(10) Pub. No.: US 2022/0397525 A1
(43) Pub. Date: Dec. 15, 2022

(54) APPARATUS AND METHOD FOR VERIFYING OPTICAL FUNCTIONALITY IN A CHAMBERLESS SMOKE DETECTOR

(71) Applicant: CARRIER CORPORATION, Palm Beach Gardens, FL (US)

(72) Inventors: Slade R. Culp, Coventry, CT (US); Joseph Anthony Vidulich, Englewood, FL (US)

(21) Appl. No.: 17/834,083

(22) Filed: Jun. 7, 2022

Related U.S. Application Data
(60) Provisional application No. 63/208,729, filed on Jun. 9, 2021.

(51) Int. Cl. G01N 21/53; G01N 21/94; G08B 17/103

(52) U.S. Cl. CPC G01N 21/53; G01N 21/94; G08B 17/103; G01N 2201/062

(57) ABSTRACT

A chamberless smoke detector includes at least one light emitter and at least one light receiver and a transparent sheet above the at least one light emitter and the at least one light receiver.

### CROSS-REFERENCE TO RELATED APPLICATIONS

This application claims the benefit of Provisional Application No. 63/208,729 filed Jun. 9, 2021, the disclosure of which is incorporated herein by reference in its entirety.

### BACKGROUND

The embodiments disclosed herein relate to smoke detectors and, more particularly, to photoelectric smoke detectors.

A smoke detector is a device that detects smoke and issues an alarm. A photoelectric smoke detector is a type of smoke detector that works based on light reflection principals and generally includes a light emitter, a light receiver, and an optic chamber. When there is no smoke in the optic chamber and the optic chamber is empty or mostly empty, the light receiver typically receives a small amount of light reflected from chamber surfaces. On the other hand, when smoke is present in the optic chamber, the light receiver receives more light due to that light being reflected from the smoke particles. When an amount of the received light exceeds a threshold level, an alarm is triggered. Chamberless (open) smoke detectors also have a light emitter and a light receiver but do not use an optic chamber.

The light emitter must be periodically evaluated to ascertain that the light is being emitted as expected and the light receiver is working as expected. While methods and apparatus for evaluating light emitter function is established for smoke detectors having an optic chamber there is a need for methods and apparatus for evaluating light emitter function in chamberless smoke detectors.

### BRIEF DESCRIPTION

According to an embodiment, a chamberless smoke detector includes at least one light emitter and at least one light receiver and a transparent sheet above the at least one light emitter and the at least one light receiver.

The transparent sheet may be in contact with the at least one light emitter, the at least one light receiver, or both.

In addition to one or more of the features described above, or as an alternative, in further embodiments the transparent sheet is a sheet of glass, plastic, or sapphire. The sheet may have a thickness of 0.01 to 0.1 inches, or, 0.01 to 0.05 inches.

In addition to one or more of the features described above, or as an alternative, in further embodiments the at least one light receiver receives light at different angles.

In addition to one or more of the features described above, or as an alternative, in further embodiments the at least one light emitter emits multiple wavelengths.

In addition to one or more of the features described above, or as an alternative, in further embodiments the smoke detector includes a light mold.

In addition to one or more of the features described above, or as an alternative, in further embodiments the transparent sheet has anti-static properties, hydrophobic properties, hydrophilic properties, a combination of anti-static and hydrophobic properties, or a combination of anti-static and hydrophilic properties. These properties may be the result of coatings or the result of multiple layers.

According to another embodiment, a method for evaluating light emitter function of a chamberless smoke detector includes transmitting light from at least one light emitter laterally through a transparent sheet to at least one light receiver, converting the received light to a signal, conveying the signal to a control unit and evaluating the conveyed signal.

In addition to one or more of the features described above, or as an alternative, the control unit alters electrical control of the light emitter, the light receiver or both based on evaluation of the conveyed signal.

In addition to one or more of the features described above, or as an alternative, transmitting light from at least one light emitter is performed at a single current and evaluating the conveyed signal comprises comparing the conveyed signal to a baseline value.

In addition to one or more of the features described above, or as an alternative, transmitting light from at least one light emitter is performed at multiple currents and results in multiple signals which are evaluated by determining a change in conveyed signal to current and comparing the change to a threshold value.

### BRIEF DESCRIPTION OF THE DRAWINGS

The following descriptions should not be considered limiting in any way. With reference to the accompanying drawings, like elements are numbered alike:

FIG. 1 is a cross section of an exemplary smoke detector; and

FIG. 2 is a top view of an exemplary smoke detector.

### DETAILED DESCRIPTION

A detailed description of one or more embodiments of the disclosed apparatus and method are presented herein by way of exemplification and not limitation with reference to the Figures.

Light emitting diodes (LED) age during operation and over time have reduced light output. Light receivers such as photodiodes have negligible aging. LED performance needs to be monitored to maintain smoke detector functionality. Previously LED performance has been monitored and evaluated by using a light receiver directly optically coupled to the LED or by using a light receiver for detecting light reflected by a surface within the detector.

In contrast, the apparatus and method described herein employ light laterally transmitted within a transparent sheet to evaluate the performance of the light emitter in a chamberless smoke detector. Chamberless smoke detectors do not require the introduction of a gas sample or particulate matter into a chamber. Light laterally transmitted within a transparent sheet is typically described as cross talk and contributes to the signal noise in an optical detection system. Surprisingly, the signal generated by the light receiver in response to the light laterally transmitted within a transparent sheet can be used to evaluate the condition of the light emitter. By using different drive currents the change in counts (signal) compared to current can be used to evaluate the output of the LED. If a single drive current is used then decreased light intensity compared to a baseline value indicates decreased output from the LED. The magnitude of the output decrease determines whether the current to the LED can be increased to increase output, the gain of the photo receiver increased, or if LED replacement is required.

Furthermore, the presence of dust or debris on the transparent sheet can be detected as well. A single current may be used to detect dust or debris by comparing the change in signal to a baseline value. If the light intensity increases compared to the baseline value then dust accumulation is indicated. Additionally, the rate of change in signal can be used to distinguish an obstruction from dust or debris accumulation.

The change in the intensity of received light at multiple wavelengths relative to baseline values can also be used to evaluate LED output and dust accumulation.

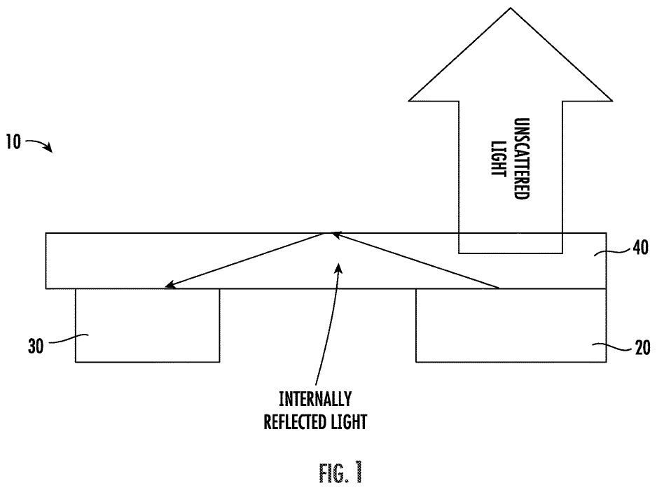

FIG. 1 is a cross section of a smoke detector 10 having a light emitter 20, a light receiver 30, and a transparent sheet 40 located above the light emitter and the light receiver. In embodiments where there is more than one light receiver each receiver may have a transparent sheet located above the receiver and optically connected to one or more emitters. It is also contemplated that a transparent sheet may extend over multiple light receivers. The transparent sheet may be optically connected to multiple light emitters.

The light emitter pulses light and a portion of the emitted light passes into the transparent sheet and is transmitted laterally to the light receiver 20. The light receiver converts the laterally transmitted light to a signal that is evaluated by a control unit (not shown).

In embodiments where a single current to the emitter is used the control unit compares the signal to a baseline value and the difference from the baseline value is compared to a threshold value. The control unit then modifies control of the LED as needed or sends a failure warning for replacement.

In embodiments where multiple currents to the emitter are used the control unit determines the slope of the received signal to current and compares the slope to a threshold value. The control unit then modifies control of the LED as needed or sends a failure warning for replacement.

The transparent sheet can be in contact with the light emitter, the light receiver or both. The transparent sheet can be formed from glass, plastic, or sapphire. The transparent sheet may have a thickness of 0.01 to 0.10 inches, or, 0.01 to 0.05 inches. The transparent sheet may be a layered material. Additionally, it is contemplated that multiple sheets could be bridged together laterally to extend over the light emitter and light receiver.

The transparent sheet may have anti-static properties, hydrophobic properties, hydrophilic properties, a combination of anti-static and hydrophobic properties, or a combination of anti-static and hydrophilic properties. These properties may be the result of coatings or the transparent sheet may be a layered material which includes one or more layers that provide anti-static properties, hydrophobic properties, hydrophilic properties, a combination of anti-static and hydrophobic properties, or a combination of anti-static and hydrophilic properties.

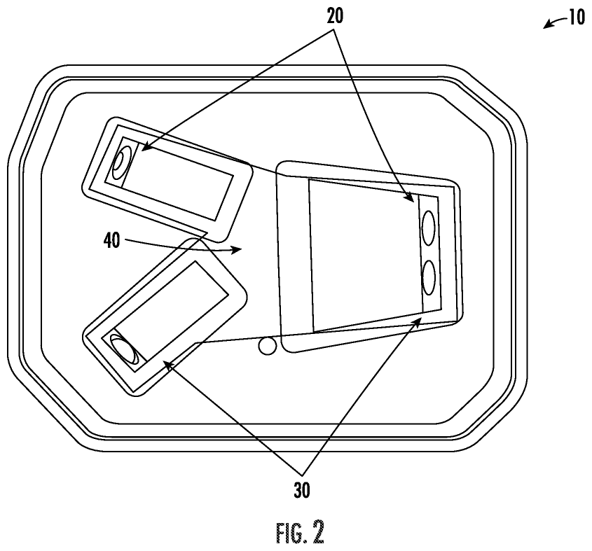

FIG. 2 is a top view of a smoke detector 10 having two light emitters 20, two light receivers 30, and a transparent sheet 40 extending over the light emitters and light receivers.

In this specification, the term “light” means coherent or incoherent radiation at any frequency or a combination of frequencies in the electromagnetic spectrum. The smoke detector 10 uses light scattering to determine the presence of particles in the sampling space to indicate the existence of a threshold condition or event. In this specification, the term “scattered light” may include any change to the amplitude/intensity or direction of the incident light, including reflection, refraction, diffraction, absorption, and scattering in any/all directions. Light is emitted through the transparent sheet into a space; when the light encounters an object suspended (i.e. floating) within the surrounding medium (air) (a smoke particle or gas molecule for example), the light will be scattered and/or absorbed due to a difference in the refractive index of the object compared to the surrounding medium (air). Depending on the object, the light can be scattered in all different directions. Detecting light scattered by an object can provide information about the space including determining the presence of a threshold condition or event.

Light scattering is a physical property attributed to the interaction of light with the atoms or surface that make up the material. The angle of redirection for light emitted from a source is dependent on the material composition and geometry. The redirection of light can be isotropic, where every angle receives the same quantity of radiation. In addition, the redirection of light can be anisotropic or the redirection of a quantity of light non-uniformly with respect to angle. The amount of anisotropy is dependent on the optical and electronic properties combined with geometric properties of the material. The anisotropy is also frequency dependent. In practice this principle can be utilized for discriminating one material from another material; a group of materials from another group of materials; or combinations of materials and groups of materials.

The smoke detector 10 includes at least one light emitter and at least one light receiver. The at least one emitter may be capable of emitting multiple wavelengths. Multiple emitters may be used to generate multiple wavelengths. The at least one receiver may be capable of detecting (receiving) multiple wavelengths. The ability to emit and detect multiple wavelengths facilitates in distinguishing different types of materials in the sampling space. The emitter and receiver may include fiber optic cables, laser diodes, photodiodes, or other types of light production and reception.

The light interacts with any particles present in the space adjacent to the smoke detector and is reflected or transmitted back to the receiver. A comparison of the light provided by the emitter and/or changes to the light reflected back to the receiver will indicate whether or not changes in the atmosphere are present in the space that are causing the scattering of the light. The scattered light as described herein is intended to additionally include reflected, transmitted, and absorbed light. Although the detection system is described as using light scattering to determine a condition or event, embodiments where light obscuration, absorption, and fluorescence is used in addition to or in place of light scattering are also within the scope of the disclosure.

In some embodiments, light from the smoke detector passes through a light mold, guide, lens, or other distribution device. The light mold enables collection of light from multiple angles. The light mold can be fabricated from any suitable material, including but not limited to, fiber optics, free space optics, molded plastic optics or photonic integrated circuits for example. In addition, the light mold and the emitter, receiver or both may be integrated.

The smoke detector 10 may be used to distinguish smoke from other types of hazardous conditions or nuisances. Each emitter is associated with one or more receivers for collecting/receiving scattered light from the space. Each of the one or more of receivers is oriented at a different angle relative to the emitter. For example, a first angle is formed between the emitter and the first receiver, and a second angle is formed between the emitter and the second receiver. The first angle and the second angle are known and are distinct. In some embodiments, the different angles can be achieved by physically orienting/positioning the receivers differently. In other embodiments, the different angles can be achieved by using a plurality of emitters. In other embodiments, a light mold can be used to receive scattered light from different scattering angles at the one or more receivers. The light mold can be operably connected to and configured to support the emitter and the plurality of receivers such that the plurality of receivers each receive scattered light from a desired angle.

The photoelectric detection system may include a control unit (not shown). The control unit may be utilized to manage the detection system operation and may include control of components, data acquisition, data processing and data analysis. In some embodiments the detection system may include other components to detect other conditions such as air quality. The control unit includes a processor and memory. Exemplary processors include microprocessors, system on a chip (SOC), field programmable gate array (FGPA), and the like. The processor may be coupled to the at least one light emitter and the at least one light receiver. The at least one light receiver is configured to convert the received scattered light into a corresponding signal receivable by the processor. The signal outputs may be compared by the processor to the signal from the emitted light to determine whether a threshold condition is present.

In addition to being operably coupled to the at least one emitter and to the at least one receiver, the control unit may be associated with one or more input/output devices. In an embodiment, the input/output devices may include an alarm or other signal, or a fire suppression system which are activated upon detection of a predefined event or condition. It should be understood herein that the term alarm, as used herein, may indicate any of the possible outcomes of a detection.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components and include embodiments which consist of the stated features, integers, steps, operations, elements, and/or components. The terms “comprises” and/or “comprising,” do not preclude the presence or addition of one or more other features, integers, steps, operations, element components, and/or groups thereof

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A chamberless smoke detector comprising at least one light emitter and at least one light receiver and a transparent sheet located at a vertical distance from the at least one light emitter and the at least one light receiver.

2. The smoke detector of claim 1, wherein transparent sheet may be in contact with the at least one light emitter, the at least one light receiver, or both.

3. The smoke detector of claim 1, wherein the transparent sheet is a sheet of glass, plastic, or sapphire.

4. The smoke detector of claim 1, wherein sheet has a thickness of 0.01 to 0.1 inches.

5. The smoke detector of claim 1, wherein sheet has a thickness of 0.01 to 0.05 inches.

6. The smoke detector of claim 1, wherein the at least one light receiver receives light at different angles.

7. The smoke detector of claim 1, wherein the at least one light receiver detects multiple wavelengths.

8. The smoke detector of claim 1, further comprising a light mold.

9. The smoke detector of claim 1, wherein the transparent sheet has anti-static properties, hydrophobic properties, hydrophilic properties, a combination of anti-static and hydrophobic properties, or a combination of anti-static and hydrophilic properties.

10. The smoke detector of claim 9, wherein the anti-static properties, hydrophobic properties, or hydrophilic properties are the result of a coating.

11. The smoke detector of claim 9, wherein transparent sheet has multiple layers and the anti-static properties, hydrophobic properties, or hydrophilic properties are the result of one or more layers

12. A method for evaluating light emitter function of a chamberless smoke detector comprising transmitting light from at least one light emitter laterally through a transparent sheet to at least one light receiver, converting the received light to a signal, conveying the signal to a control unit and evaluating the conveyed signal.

13. The method of claim 12, wherein the control unit alters electrical control of the light emitter based on evaluation of the conveyed signal.

14. The method of claim 12, wherein the control unit alters electrical control of the light receiver based on evaluation of the conveyed signal.

15. The method of claim 13, wherein transmitting light from at least one light emitter is performed at a single current and evaluating the conveyed signal comprises comparing the conveyed signal to a baseline value.

16. The method of claim 13, wherein transmitting light from at least one light emitter is performed at multiple currents and evaluating the conveyed signal comprises determining a change in conveyed signal to current and comparing the change to a threshold value.
